(19) United States
(12) Patent Application Publication
(10) Pub. No.: US 2026/0140804 A1
(43) Pub. Date: May 21, 2026

(54) METHOD FOR DETECTING AN ANOMALY IN AN OBSERVED TIME SERIES OF VALUES OF A PHYSICAL QUANTITY REPRESENTATIVE OF THE PERFORMANCE OF A SYSTEM

(71) Applicant: WORLDLINE, Puteaux (FR)

(72) Inventors: Etienne Matthieu KRONERT, Lille (FR); Dalila HATTAB, Gondecourt (FR)

(73) Assignee: WORLDLINE, Puteaux (FR)

(21) Appl. No.: 19/121,037

(22) PCT Filed: Oct. 4, 2023
(86) PCT No.: PCT/FR2023/051529

§ 371 Date: Apr. 14, 2025

(30) Foreign Application Priority Data
Oct. 12, 2022 (FR) FR22/10466
Feb. 22, 2023 (FR) FR23/01611

(51) Int. Cl. G06F 11/07

(52) U.S. Cl. CPC G06F 11/0751; G06F 11/0721

(57) ABSTRACT

A method for detecting an anomaly in an observed time series of values of a physical quantity representative of the performance of a system, the method being characterised in that it involves implementing, via data-processing means of a server, steps of: (a) determining a residue corresponding to the observed time series from which a predictable portion of the observed time series has been removed; (b) segmenting the residue into a plurality of successive segments minimising a score representative of the intra-segment inhomogeneity; and (c) for at least the most recent segment, statistically analysing the distribution of the values of the residue in the segment so as to conclude whether or not there is an anomaly on the segment.

### GENERAL TECHNICAL FIELD

The present invention relates to the field of monitoring, in particular in computer data. More specifically, it relates to a method for detecting an anomaly in an observed time series of values of a physical quantity representative of the performance of a system.

### STATE OF THE ART

The monitoring is an activity of monitoring and measuring a computer activity, with the aim of supervision.

In particular, we can seek to observe the performance of a computer system, in terms of response time for example, its availability, its integrity, etc.

In general, the values of various physical quantities (called “metrics”) are measured over time, and we seek to identify or even predict anomalies from these values, so as to put in place alerts and correction mechanisms before an incident. The term “time series” refers to the set of successive values of a metric and the corresponding curve.

For example, FIG. 1 is a time series illustrating the CPU usage rate of a computer system (over a period of one week). Each circle is a noted anomaly and we notice, for example, on July 19, cascading anomalies that led to a brief drop in this CPU usage to 0% for a few hours, causing a service interruption. We also see other moderate variations in the rate that may or may not be related to anomalies.

The naive monitoring solution consists of setting thresholds and detecting when they are crossed, which is insufficient in practice: each system is different and has its own behavior.

And even assuming that we define individual thresholds, the behavior of the metrics can evolve over time without there being an anomaly, and conversely we can have an anomaly while having a metric that is maintained.

In the example in FIG. 1, we can, for example, set a threshold of 80% CPU usage (below which we consider that we are in the presence of an anomaly) which proves relevant in the majority of cases. However, during the initial set of anomalies at dawn on July 19 (which will lead to a cascade of other anomalies and the total interruption of the service) the CPU usage is nevertheless at nearly 95%, and therefore well above the detection threshold.

Therefore, solutions based on the determination of confidence intervals dynamically have been proposed.

In particular, application EP3672153 proposes to determine a “residue” corresponding to what remains of a metric once a predictable component (corresponding to a normal behavior) has been removed, and to calculate confidence intervals (with thresholds) on these residues.

This method is satisfactory, but it would be desirable to further improve its precision and thus decrease the number of false positives/negatives.

### PRESENTATION OF THE INVENTION

The present invention therefore relates, according to a first aspect, to a method for detecting an anomaly in an observed time series of values of a physical quantity representative of the performance of a system, the method being characterized in that it involves implementing, by data-processing means of a server, steps of:
(a) Determining a residue corresponding to said observed time series from which a predictable part of said observed time series has been removed;
(b) Segmenting the residue into a plurality of successive segments minimizing a score representative of the intra-segment inhomogeneity;
(c) For at least the most recent segment, statistically analyzing the distribution of the values of the residue in said segment so as to conclude whether or not there is an anomaly on the segment.

According to advantageous and non-limiting characteristics:

Step (a) comprises determining, from the observed time series, said predictable part; and subtracting said predictable part, from the time series, so as to obtain said residue.

Determining the predictable part comprises implementing on the observed time series a prediction model trained on a basis of reference time series of the same physical quantity representative of the performance of the system.

The method comprises a step (a0) of acquiring said observed time series of values of the physical quantity representative of the performance of the system, by the system or by means for monitoring the system.

Step (b) comprises proposing a plurality of candidate segmentations, in particular each defining a number of different segments, and selecting the candidate segmentation having said lowest score representative of the intra-segment inhomogeneity.

Step (c) comprises constructing a possible statistical model of the values of the residue in the segments, and for at least said most recent segment, determining a p value for said statistical model of the distribution of the values of the residue in said segment.

An anomaly is concluded at step (c) if said p value is below a threshold.

The threshold is predetermined, in particular 5%.

Said threshold is calculated for a desired false positive rate, in particular by using the Benjamini Hochberg method.

Said desired false positive rate on the segment for which the p value is determined is calculated based on a desired false positive rate over the entire time series.

A first threshold calculated for the desired false positive rate over the entire time series, and a second threshold calculated for said desired false positive rate over the segment, are successively applied.

Step (c) comprises constructing a plurality of possible statistical models of the values of the residue in the segments, and selecting for at least said most recent segment a best model of said plurality for which the p value is determined, said best model being the one best describing the tails of said distribution of the values of the residue in said most recent segment.

The method comprises a step (d) of implementing an action if an anomaly is detected on at least one segment.

Step (d) comprises triggering an alert and/or requesting equipment for diagnosing and maintaining the system.

According to a second aspect, the invention relates to a server for detecting an anomaly in an observed time series of values of a physical quantity representative of the performance of a system, characterized in that it comprises data-processing means configured to:
Determine a residue corresponding to said observed time series from which a predictable part of said observed time series has been removed;
Segment the residue into a plurality of successive segments minimizing a score representative of the intra-segment inhomogeneity;
For at least the most recent segment, implement a statistical analysis of the distribution of the values of the residue in said segment so as to conclude whether or not there is an anomaly on the segment.

According to a third aspect, the invention relates to an assembly of the server according to the second aspect, of the system and of equipment for diagnosing and maintaining the system.

According to fourth and fifth aspects, the invention relates to a computer program product comprising code instructions for the execution of a method according to the first aspect for detecting an anomaly in an observed time series of values of a physical quantity representative of the performance of a system; and a storage means readable by computer equipment on which is recorded a computer program product comprising code instructions for the execution of a method according to the first aspect for detecting an anomaly in an observed time series of values of a physical quantity representative of the performance of a system.

### PRESENTATION OF THE FIGURES

Other characteristics and advantages of the present invention will become apparent upon reading the following description of a preferred embodiment. This description will be given with reference to the appended drawings in which:

FIG. 1 previously described represents an example of a time series with the noted anomalies;

FIG. 2 is a diagram of a system for implementing the method according to the invention;

FIG. 3 is a flowchart representing the steps of a preferred embodiment of the invention;

FIG. 4 illustrates the determination of the residue from an example of observed time series;

FIG. 5 represents a case of reference segment constructed on the basis of the current segment under analysis and the segment very similar in terms of mean and variance already analyzed in the near past;

FIG. 6 illustrates the segmentation of the residue of the example in FIG. 4;

FIG. 7 represents a case of reference segment constructed on the basis of the current segment being analyzed and the segment very similar in terms of mean and variance already analyzed in the near past;

FIG. 8 represents an example of probability density on the segment of FIG. 7.

FIG. 9 illustrates the result of implementing the statistical analysis on the current segment of the example in FIGS. 4, 6 and 7. The current segment in FIG. 9 corresponds to that of FIG. 7 fed with more data allowing robust anomaly detection.

FIG. 10 corresponds to FIG. 9 using thresholds calculated for desired false positive rates.

FIG. 11 is a graph illustrating optimal control of the false positive rate.

### DETAILED DESCRIPTION

### Architecture

The present invention relates to a method for detecting an anomaly in an observed time series of values of a physical quantity representative of the performance of a system 2.

The system 2 is typically a computer server providing a service, for example a network equipment, a banking server implementing transactions, an industrial control equipment, etc. It is assumed that that we have a physical quantity representative of the performance of said system 2.

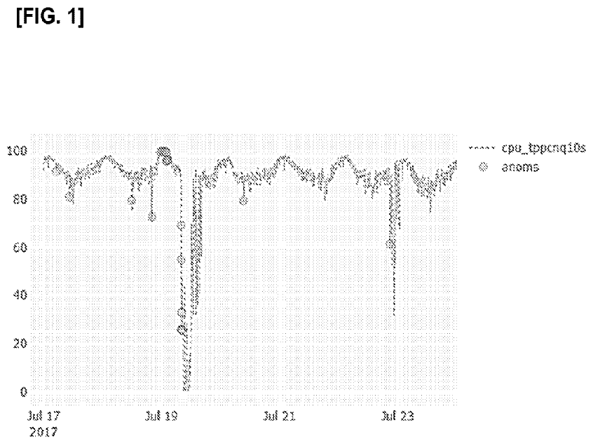

Said physical quantity is naturally chosen in accordance with the nature of the system 2 and the service it provides, for example for a network equipment we can take the CPU usage (example of FIG. 1 described previously), but also a memory usage, a bandwidth, a number of connected users, a number of packets passed, etc. For a banking server, this quantity can be the number of transactions completed, the rate of rejected transactions, etc. For an industrial control equipment, it can be a quantity involved in the industrial process such as a temperature, a pressure, etc.

We will not be limited to a type of system or to a physical quantity, it is just important that said physical quantity is representative of the performance of this system 2, i.e. has meaning for the person skilled in the art with regard to the service provided by the system 2.

A time series of values of the physical quantity is understood to mean a sequence of values over time, each corresponding to an observation of the system 2, for example, one value per minute. Said time series can be seen as a vector of values. Here, we speak of an “observed” time series as being the series of values currently examined, as opposed to “reference” time series, which correspond to particular past examples constituting a learning base.

The observed time series can be directly acquired by the system 2, or by means 20 for monitoring the system 2.

Said method is a method for detecting an anomaly in the time series, that is to say, it aims to determine whether the values are normal or not. More precisely, although there is a normal variability of the values that is expected, as explained before, some values may in practice be abnormal and constitute weak signals that a degradation of the performance of the system is in progress or imminent, and we speak of an incident when the system 2 is no longer able to perform its service. In the example in FIG. 1, a network equipment whose CPU usage collapses is no longer able to properly manage the network traffic, and users will quickly experience slowdowns or even disconnections. To rephrase, the incident is the consequence of an anomaly.

The notion of anomaly is in itself statistical, the causes can be very varied, and the objective of the present method is not in itself to determine these causes, but simply to alert and launch corrective actions as soon as possible so as to avoid or at least limit the incident (diagnosis, troubleshooting, starting up a backup system, etc.), as well as to identify and evaluate types of anomalies according to selection filters and appropriate criteria.

In the case of the present detection method, we seek to avoid false negatives (cases in which an anomaly is not detected) and false positives (cases in which we believe we have detected an anomaly but in fact there is nothing).

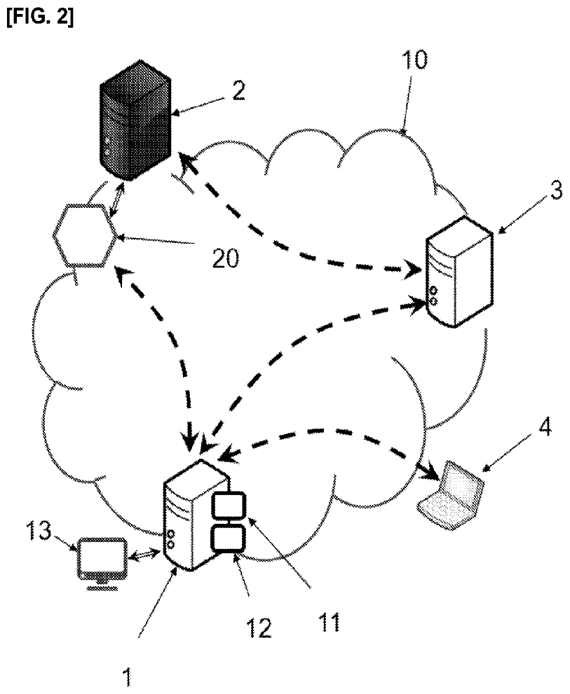

With reference to FIG. 2, the method is implemented by a server 1 comprising data-processing means 11 (typically a processor), and generally data-storage means 12 (a memory). The server 1 is also provided with an interface 13 for reporting the detected anomalies, this may be an HMI but also means for connecting to other diagnostic and maintenance equipment 3 and/or a terminal 4 for example of an administrator.

The connection between the different equipment (servers 1, 3, system 2, means 20 and/or terminal 4) can be via a communication network 10 such as the Internet.

### Method

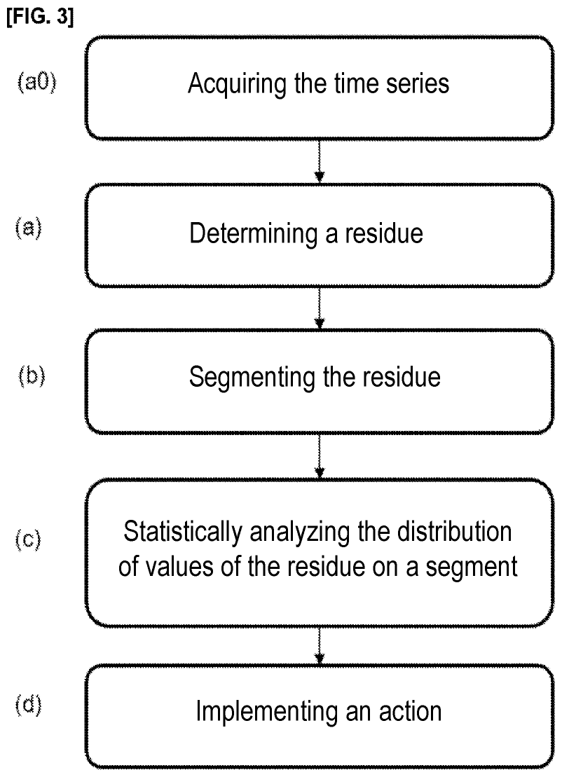

With reference to FIG. 3, the present method typically begins with a step (a0) of acquiring said observed time series of values of the physical quantity representative of the performance of the system 2, for example by the means 20. Typically, the performance of the system 2 is observed at regular intervals and a new value completing the series is acquired at each observation. It will be understood that system monitoring is well known to those skilled in the art. In network applications, the order of magnitude is typically one observation per second.

The series can be provided to the server 1 at once, or value by value (in particular in real time) in a tail and reconstituted. The method can also be implemented for each new value obtained. It will be understood from this point of view that the present method can be implemented as well:
in isolation for an entire time series, and we seek to detect a posteriori whether the series included anomalies, or
in an iterative manner and in particular in real time, and we then seek to proactively detect for each new observation whether we are in the presence of an anomaly (we seek to detect as early as possible or even anticipate an incident).

In all cases, the time series is advantageously timestamped, i.e. associated with an initial timestamp (of the first value) and/or a final timestamp (last value) corresponding to the observation times.

In a step (a), which is the first step of processing the observed time series implemented by the data-processing means 11 of the server 1, a “residue” of the observed time series is determined. The residue corresponds to said observed time series from which a predictable part, i.e. the prediction error, has been removed. The residue and the predictable part are in themselves time series of values.

In this respect, step (a) preferably comprises:
the determination, from the observed time series, of said predictable part, and
the subtraction of said predictable part from the observed time series, i.e. for each value of the time series we subtract the corresponding value of the predictable part.

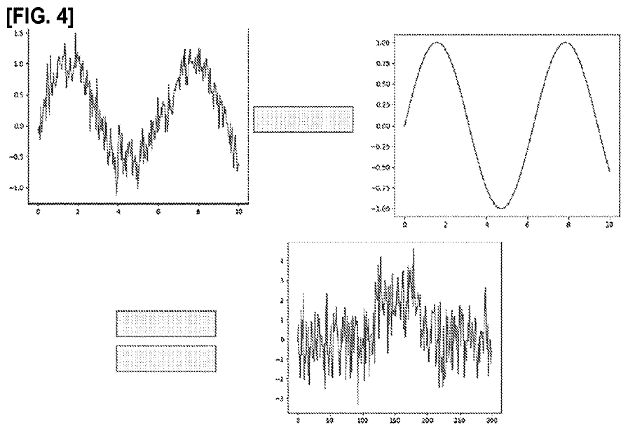

This step (a) is particularly illustrated by FIG. 4: we see from left to right the time series, the predictable part and the obtained residue.

The idea is to consider that the observed time series is the sum of a “normal” behavior and of an “abnormal” behavior of the physical quantity. The normal behavior is expected, and can therefore be predicted, unlike abnormal behavior, which is random.

In this respect, we know artificial intelligence models, and in particular artificial neural networks such as N-beats, capable of predicting time series.

Thus, in a preferred embodiment, the server 1 has a prediction model taking as input the observed time series and generating as output said predictable part of the observed time series.

This prediction model can be trained in an unsupervised manner from a learning base of reference time series of the same physical quantity representative of the performance of the system 2 (i.e. no label is associated with these reference series), advantageously corresponding to past observations under comparable conditions. Indeed, said physical quantity varies for example naturally during the day, and this “normal” trend can be apprehended by said prediction model.

For this, the server 1 can store said learning base on its data-storage means 12 and the data-processing means 11 can implement the learning of the prediction model, even if it is entirely possible that this is done by a separate server, and the learned model directly retrieved by the server 1.

It will be understood that such a model and its learning are well known to those skilled in the art; it will be possible to use the N-beats model cited above or, for example, other recurrent networks such as LSTM adapted to the prediction of time series. It will also be possible to consult the application EP3672153 cited above.

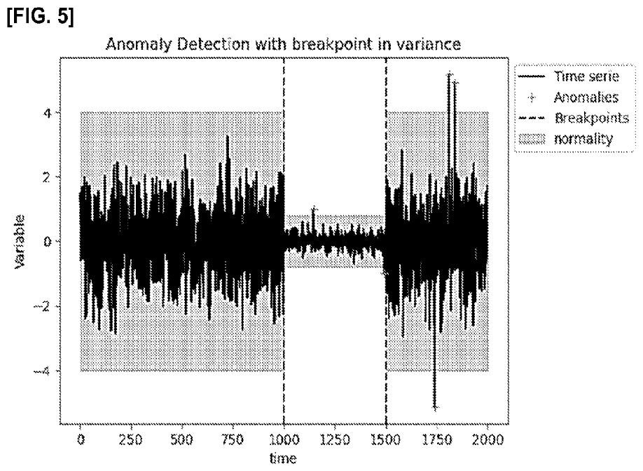

Originally, in a step (b) the data-processing means 11 implement a segmentation of the residue into a plurality of successive segments minimizing a score representative of the intra-segment inhomogeneity. Inhomogeneity, or heterogeneity, here designates the variability of the law which generates the values which are observed, and in practice the variability of the values of the residue, which is translated for example by changes in the variance. A perfectly homogeneous segment will present a constant residue over its entire extent. On the contrary, a very inhomogeneous segment will have a large extent of residue values. Note that only intra-segment inhomogeneity (i.e. within the segments) is targeted here, the possible inter-segment inhomogeneity (i.e. of one segment compared to another) not being considered. As an example, FIG. 5 represents the values of a time series, and we note the existence of a change in the variance which defines a central segment.

Segmentation means the division of the residue into n successive segments. It will be understood that, in the same way as the values of the physical quantity, the segments are ordered temporally, and therefore the “last” segment is the most recent.

The segmentation aims more precisely to determine the n−1 breakpoints which constitute the most abrupt points of change (heterogeneities), and where the boundaries between segments are placed.

The idea is that we can obtain segments that are themselves homogeneous on which we can implement an efficient statistical analysis.

The known techniques in fact implemented a global or sliding window statistical analysis, and we note that working segment by segment allows for more precise adaptation to variations in the mean and variance.

For example, if we take FIG. 1, the anomalies of July 19 morning were certainly at nearly 95% CPU usage, but we already had a drop and therefore a variance that was too sudden compared to a normal behavior (which is close to the sinusoid—while the drop before the total incident is almost linear). The segmentation would have brought out a specific segment corresponding to this morning of July 19.

To implement step (b) in practice, any known breakpoint detector can be used, including those used in the context of the genetic analysis (for example to analyze copy number variations in DNA). Or, for example, the so-called “KernSeg” methods described in the document New efficient algorithms for multiple change-point detection with reproducing kernels, A. Celisse, G. Marot, M. Pierre-Jean, G J Rigaill.

Preferably, the processing means 11 propose a plurality of candidate segmentations, preferably at least one candidate segmentation per value of the number n of segments, then calculate for each the value of said score representative of the intra-segment inhomogeneity. The candidate segmentation presenting said score representative of the lowest intra-segment inhomogeneity is then chosen, that is to say the one which minimizes the score among all the candidate segmentations.

Regarding the score, we can in particular take a score per segment (for example the deviation from the mean of the segment, but we can use any cost function that tends towards 0 when the segment tends towards a constant value), and sum the scores of segments. However, we will prefer scores based on the reproducing kernels, allowing the detection of all types of breaks and not only breaks in the mean (for example, changes in variance).

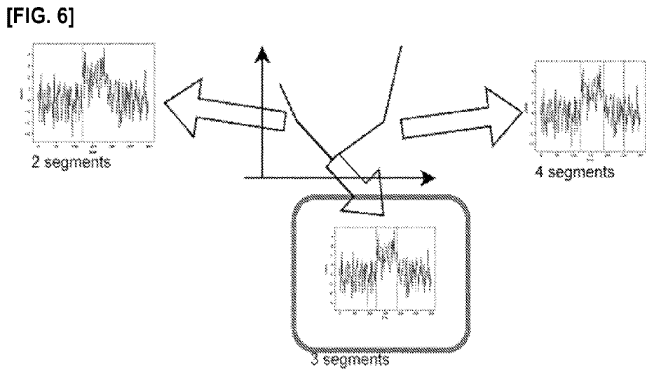

FIG. 6 represents the candidate segmentations obtained for the residue of FIG. 4 respectively for n=2, 3 and 4, as well as the corresponding inhomogeneity score. We see that this score has its minimum for n=3, because at n=2 the second segment is too inhomogeneous, and at n=4+ we have too many segments.

Note that in real-time operation, we generally already know the previous completed segments (due to the iterated implementation of the method) and we have a “current” (the most recent) segment. With each new observation, the breakpoint detection determines whether to continue the current segment, or whether on the contrary a new segment has started (retroactively the algorithm can fragment the current segment by placing a posteriori a breakpoint several observations before).

Preferably, at the end of step (b) it is verified that each segment (in particular the current segment) has a size above a predetermined significance score. To rephrase, a segment that is too short may not comprise enough value to allow a relevant statistical analysis, and this generally happens in real-time operation when a new segment begins.

If this is the case, we can add to a segment that is too short the values of a similar previous segment for the next step. Of course, as soon as the current segment is long enough due to new observations we can stop using these previous values.

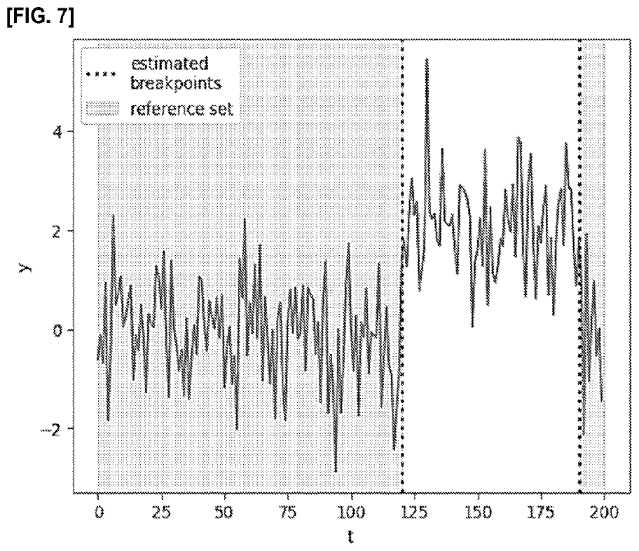

For example, in the case of FIG. 7, the segmentation obtained again comprises three segments but the last one is too short: we only have 12 seconds of observations. If the significance threshold is, for example, 30 seconds, it is necessary to add this third segment to the most similar previous segment, in this case the first. It is then this set of segments that serves as a reference to define normality.

In a step (c), for at least the current segment (and possibly for each segment if the entire series is processed a posteriori), the distribution of the values of the residue in said segment is statically analyzed so as to conclude whether or not there is an anomaly. If the method is implemented in real time, step (c) only concerns the current segment (because it is assumed that the previous segments have already been analyzed as they were), but alternatively, if the entire series is processed a posteriori, step (c) is implemented for each segment identified in step (b).

Classically, the residue should present a Gaussian distribution of values, i.e. in accordance with a centered normal law (around 0), and we check whether the noted distribution is compatible with such a law in probabilistic terms. In more realistic cases, the obtained distribution is not always Gaussian, the statistical analysis of the residues and the detection of the anomalies is then more difficult with classical methods.

The statistical analysis thus aims to determine whether the noted distribution is “explainable” by statistical fluctuations, or on the contrary that it is not and therefore that we are in the presence of an anomaly. Any known method may be used, and in particular those cited in application EP3672153, but advantageously, at least one possible statistical model of the values of the residue in the segments is constructed.

We can have several candidate models corresponding to several possible distributions, and progressively update these models as we receive observations.

Preferably, the model(s) are evaluated by their ability to describe the extreme parts of the distribution, called “tails”. It is more common to select the models by their ability to accurately describe the entire distribution, but such models are biased in favor of the central part and against the tail of the distribution. However, it is precisely in the tail of the distribution that any anomalies are observed that we wish to capture.

The model or a “best model” if there are several, is chosen and used to determine alert thresholds on the values of the residue.

For example, we can use the “p value”, which refers to the probability for the chosen statistical model to obtain an error as large as the observed error (i.e. the value of the residue). Thus, a low p value corresponds to an abnormally high prediction error, and therefore that we are in the presence of an anomaly. Traditionally, a p value threshold of 5% is used.

Estimating the p value typically involves Kernel Density Estimation (KDE) applied to the tail of the distribution, which makes it possible to estimate the probability density of the residue by smoothing more or less the estimate, and the Grimshaw procedure (Computing Maximum Likelihood Estimates for the Generalized Pareto Distribution, Scott D. Grimshaw).

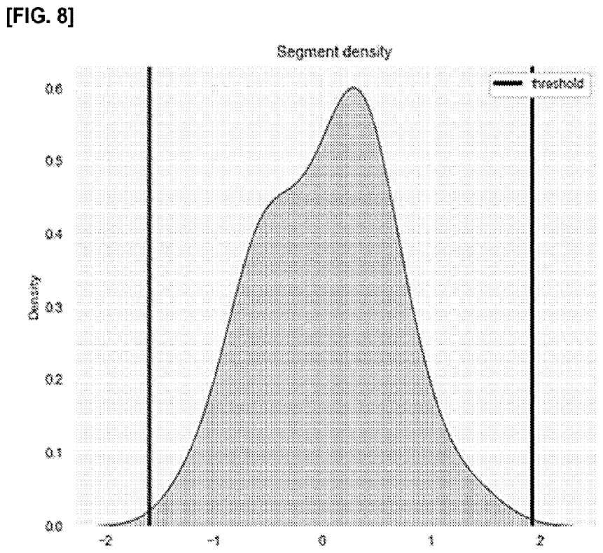

FIG. 8 represents for a segment the probability density estimated by KDE with the corresponding p value thresholds.

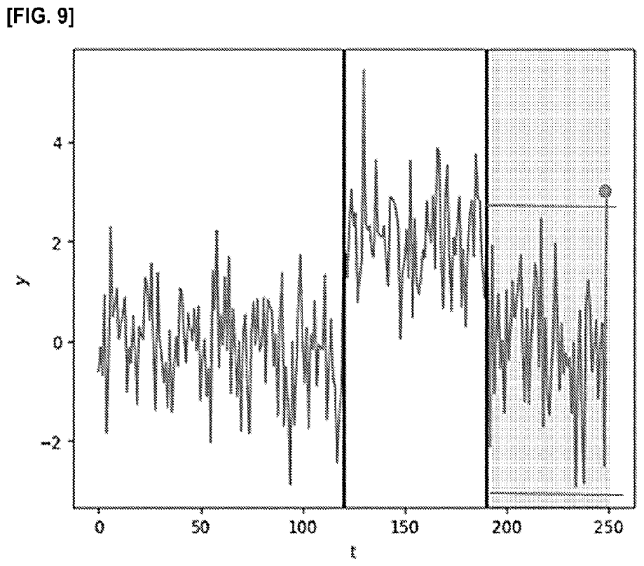

Visually, the corresponding value thresholds can be plotted on the residue: if a threshold is exceeded, an anomaly is observed, see FIG. 9. However, it should be understood that the p value can simply be determined and compared to the threshold, without recalculating the thresholds of values of the residue.

As explained the threshold can be predetermined, for example 5%, but alternatively it is calculated for a desired false positive rate on the segment considered (in particular the most recent segment), so as to be more adequate to decide on the existence of anomalies.

For this, we can use the Benjamini-Hochberg method, which defines the threshold Og for a desired false positive rate α, using the following formula:

$${θ}_{α} = arg {max}_{k} {p}_{( k )} \vert {p}_{( k )} < \frac{α k}{m} ,$$

where
p₍ₖ₎: the k-th smallest p value of the analyzed series
m: Size of the analyzed series

Those skilled in the art will be able to find alternative methods.

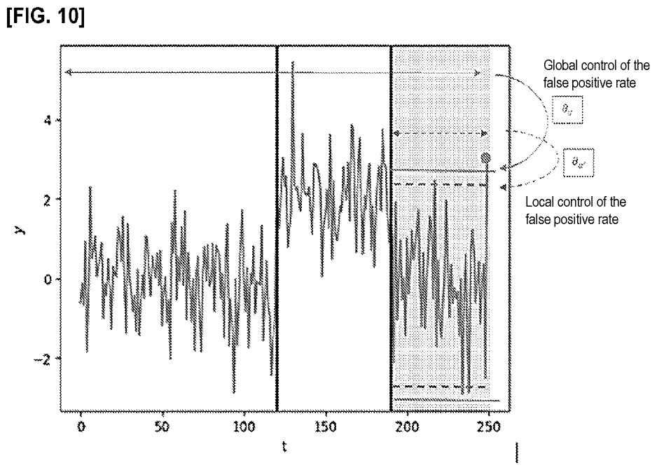

Preferably, we can even use a modified version of the Benjamini-Hochberg method:
the desired false positive rate on the considered segment (called local rate) can be predetermined, but alternatively what can be predetermined is a desired false positive rate over the entire time series (called global rate). Indeed, if we use the threshold Og then we can guarantee that the false positive rate will be lower than a on the segment but this is insufficient to guarantee control over the false positive rate in the complete series, which is why we can apply to the segment a second threshold Og calculated for a value a′ corresponding to a slight variation of the global rate α so as to guarantee said desired false positive rate over the entire time series (i.e. said desired false positive rate on the segment for which the p value is determined is calculated as a function of the desired false positive rate over the entire time series), as illustrated in FIG. 10, in order to control the false positive rate of the overall time series analyzed by controlling the false positive rate of its sub-series. In particular, we can start by calculating and applying to the considered segment the first threshold Og for the desired rate α over the entire time series (with the standard Benjamini-Hochberg method), calculating a proportion Π₁ of anomalies, and applying the formula

$${α}^{′} = \frac{α}{1 - \frac{1 - α}{{m}^{′} {\prod }_{1}}} ,$$

where m′ is the size of the anomalies, and applying the formula local sub-series (i.e. the number of values of the physical quantity in the segment). The second threshold θ_{α}′ is then calculated for the segment by applying the Benjamini-Hochberg method again but taking the rate α′.

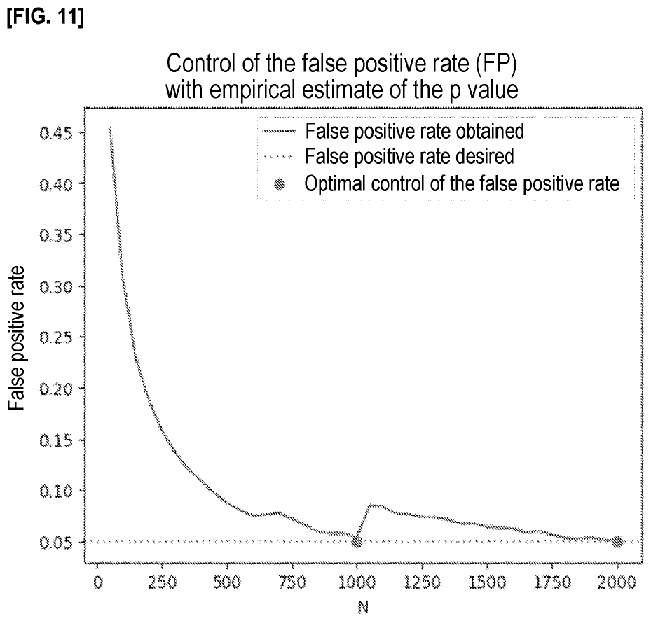

In summary, in the preferred embodiment:
a first threshold θ_{α} is calculated for a desired false positive rate α over the entire time series (predetermined), and applied to the considered segment;
a desired false positive rate α′ on the considered segment is calculated as a function of the desired false positive rate α on the entire time series (and the result of applying the first threshold θ_{α} to the segment):
a second threshold θ_{α}′ is calculated for said desired false positive rate α′ on the considered segment, and applied to the considered segment.
the reference size can be modified so as to guarantee that the error made on the estimation of the p value does not prevent control of the false positive rate, both locally and globally. Indeed, the number of points in the reference set must be chosen judiciously to best control false positives. FIG. 11 shows that the control is particularly optimal for a reference size N_{I} chosen as follows:

$${N}_{l} = l \frac{m}{α} - 1 ,$$

positive integer (usually 1 or 2) that controls the size of the reference set. Choosing a larger reference set makes it possible to decrease the number of false negatives but increases the computation time.

In all cases, the method advantageously comprises a step (d) of implementing an action if an anomaly is detected on at least one segment:
at least one alert to be triggered on an interface 13 of the server 1 or a connected terminal 4
preferably, the possible equipment 3 for diagnosing and maintaining the system 2 is requested, i.e. a request is sent to it, so that the latter implements tests to determine the nature of the anomaly, or even resolve it, if possible even before an incident occurs.

### Results

The present method has been tested for proactive detection of anomalies on a system 2 of network equipment type such as a denial of service (DDoS) attack.

We note that the server 1 manages to detect the anomaly 15 minutes earlier than using known methods with predefined thresholds.

### Server, System

According to a second aspect, the invention relates to the server 1 for implementing the method according to the invention.

This server for detecting an anomaly in an observed time series of values of a physical quantity representative of the performance of a system 2 comprises data-processing means 11, and generally data-storage means 12, for example storing a base of observed time series of values of said physical quantity representative of the performance of the system 2, and an interface 15.

The means 11 are configured to:
Determine a residue corresponding to said observed time series from which a predictable part of said observed time series has been removed;
Segment the residue into a plurality of successive segments minimizing a score representative of the intra-segment inhomogeneity:
For at least the most recent segment, implement a statistical analysis of the distribution of the values of the residue in said segment so as to conclude whether or not there is an anomaly on the segment.
Advantageously, implement an action if an anomaly is detected on at least one segment

According to a third aspect, a set of the server 1 and of the system 2 is proposed. The set may possibly comprise means 20 for monitoring the system 2, equipment 3 for diagnosing and maintaining the system 2 and/or a terminal 4. All of these elements 1, 2, 20, 3, 4 may be connected via a network 10.

### Computer Program Product

According to fourth and fifth aspects, the invention relates to a computer program product comprising code instructions for the execution (in particular on the data-processing means 11) of a method according to the first aspect of the invention for detecting an anomaly in an observed time series of values of a physical quantity representative of the performance of a system, as well as storage means readable by computer equipment (a memory 12 of the server 1) on which this computer program product is found.

1. A method for detecting an anomaly in an observed time series of values of a physical quantity representative of the performance of a system, the method being characterized in that it involves implementing, by data-processing means of a server, steps of:
(a) determining a residue corresponding to the observed time series from which a predictable part of the observed time series has been removed;
(b) segmenting the residue into a plurality of successive segments minimizing a score representative of the intra-segment inhomogeneity;
(c) for at least the most recent segment, statistically analyzing the distribution of the values of the residue in the segment so as to conclude whether or not there is an anomaly in the segment.

2. The method according to claim 1, wherein step (a) comprises determining, from the observed time series, the predictable part; and subtracting the predictable part, from the time series, so as to obtain the residue.

3. The method according to claim 2, wherein the determination of the predictable part involves implementing on the observed time series a prediction model trained on a basis of reference time series of the same physical quantity representative of the performance of the system.

4. The method according to claim 1, comprising a step (a0) of acquiring the observed time series of values of the physical quantity representative of the performance of the system, by the system or by means for monitoring the system.

5. The method according to claim 1, wherein step (b) comprises proposing a plurality of candidate segmentations, and selecting the candidate segmentation having the score representative of the lowest intra-segment inhomogeneity.

6. The method according to claim 1, wherein step (c) comprises constructing a possible statistical model of the values of the residue in the segments, and for at least the most recent segment, determining a p value for the statistical model of the distribution of the values of the residue in the segment.

7. The method according to claim 6, wherein an anomaly is concluded in step (c) if the p value is below at least one threshold.

8. The method according to claim 7, wherein the threshold is either predetermined, or calculated for a desired false positive rate on the segment for which the p value is determined.

9. The method according to claim 8, wherein the desired false positive rate on the segment for which the p value is determined is calculated as a function of a desired false positive rate on the entire time series.

10. The method according to claim 6, wherein step (c) comprises constructing a plurality of possible statistical models of the values of the residue in the segments, and selecting for at least the most recent segment a best model of the plurality for which the p value is determined, the best model being the one best describing the tails of the distribution of the values of the residue in the most recent segment.

11. The method according to claim 1, comprising a step (d) of implementing an action if an anomaly is detected on at least one segment.

12. The method according to claim 11, wherein step (d) comprises triggering an alert and/or requesting equipment for diagnosing and maintaining the system.

13. A server for detecting an anomaly in an observed time series of values of a physical quantity representative of the performance of a system wherein it comprises data-processing means configured to:
determine a residue corresponding to the observed time series from which a predictable part of the observed time series has been removed;
segment the residue into a plurality of successive segments minimizing a score representative of the intra-segment inhomogeneity;
for at least the most recent segment, implement a statistical analysis of the distribution of the values of the residue in the segment so as to conclude whether or not there is an anomaly on the segment.

14. A set of the server according to claim 13, of the system and of equipment for diagnosing and maintaining the system.

15. A computer program product comprising code instructions for the execution of a method according to claim 1 for detecting an anomaly in an observed time series of values of a physical quantity representative of the performance of a system, when the program is executed on a computer.

16. A storage means readable by computer equipment on which is recorded a computer program product comprising code instructions for the execution of a method according to claim 1 for detecting an anomaly in an observed time series of values of a physical quantity representative of the performance of a system.
